(19) United States
(12) Patent Application Publication
(10) Pub. No.: US 2008/0264403 A1
(43) Pub. Date: Oct. 30, 2008

(54) ROTATING BARBECUE GRILL

(76) Inventor: Lyndon Kurt, Bellflower, CA (US)

Correspondence Address: J C PATENTS, INC., 4 VENTURE, SUITE 250, IRVINE, CA, 92618, US

(21) Appl. No.: 11/740,207

(22) Filed: Apr. 25, 2007

(51) Int. Cl. A47J 37/07

(52) U.S. Cl. 126/25 AA

(57) ABSTRACT

A barbecue grill comprises a grill grid, a shaft for rotating the grill grid, a barbecue grill housing, such as a fire bowl, having an opening at its bottom portion where the shaft passes through the opening, an ash container removably placed beneath the opening of the fire bowl, and a motor removably coupled to the bottom of the ash container. After the barbecue is finished, the ash container and the motor can be easily removed from the fire bowl.

### BACKGROUND OF THE INVENTION

This invention relates to a barbecue grill. More particularly, the present invention relates to a barbecue grill having a rotating grill grid driven by a motor removably attached to the barbecue grill.

Conventional charcoal barbecue grills with a rotating grill grid have been developed to achieve even cooking results by rotating the grill grid and the food on the grill grid while barbecuing. U.S. Pat. No. 6,929,001 discloses a barbecue grill that realizes an even broiling and subsequent optimal barbecue, and minimizes excessive burning of food on a wire grid plate and consumption of charcoal. The barbecue grill of U.S. Pat. No. 6,929,001 comprises a gridiron disk, a shaft extending from the gridiron disk so that the shaft becomes substantially perpendicular to the gridiron disk, a bowl having a channel where the shaft is detachably received through the channel, and a motor attached to the bowl to generate rotation of the shaft.

U.S. Pat. No. 5,787,873 discloses a retro-fit barbecue grill grid gear drive assembly for attaching to a common prior-art barbecue stand. The retro-fit barbecue grill grid gear drive assembly of U.S. Pat. No. 5,787,873 comprises an electric gear drive motor or a reversible gear drive motor attached to a heat-sink perforated plate and protected in a housing. A housing extension pipe is fitted into a hole made in a fire bowl. The motor turns a drive shaft and a clamp type drive head, or other drive head and a grill grid at about 1 RPM.

However, the conventional charcoal barbecue grills discussed above have drawbacks. For example, in these conventional charcoal barbecue grills with rotating grill, the motor is fixed to the bottom of the barbecue grill. It is not convenient to remove the motor from the barbecue grill when it is not in use. In addition, as the ash is left inside the barbecue grill, it is not easy to dispose the ash after the barbecue grill is used.

### SUMMARY OF THE INVENTION

The present invention is contrived to overcome the drawbacks of conventional barbecue grills. One aspect of the invention is to provide a barbecue grill with a rotating grill grid that is driven by a motor removably attached to the barbecue grill and powered by an AC power or a battery. Another aspect of the present invention is to provide a barbecue grill wherein the ash is collected in a container positioned outside the barbecue grill housing so that it is easy to dispose the ash.

The barbecue grill according to the present invention comprises a grill grid, a shaft for rotating the grill grid, a barbecue grill housing, such as a fire bowl, having an opening at its bottom portion where the shaft passes through the opening, an ash container removably attached to the fire bowl beneath the opening of the fire bowl, and a motor removably attached to the bottom of the ash container to generate rotation of the shaft so as to rotate the grill grid. The shaft passes through the ash container and is engaged at one end with the motor. In use, the ash container is removably attached to the bottom of the fire bowl, and the motor is removably attached to the bottom of the ash container, for example, through a sliding mechanism. After the barbecue is finished, the ash container and the motor can be easily removed from the fire bowl for disposing ash and for storage. When an ash container is provided, the center opening at the bottom of the fire bowl is made large enough for ash to fall into the ash container through the center opening, and no additional air holes are needed at the bottom portion of the fire bowl.

The barbecue grill further includes a fire grid for supporting a charcoal fire. The shaft passes through the fire grid. The present invention can use any conventional fire bowls and fire grids that are suitable for charcoal fire.

In another embodiment, no separate ash container is provided. The barbecue grill according to this embodiment comprises a grill grid, a shaft for rotating the grill grid, a barbecue grill housing, such as a fire bowl, having an opening at its bottom portion where the shaft passes through the opening, and a motor removably attached to the bottom of the fire bowl to generate rotation of the shaft so as to rotate the grill grid. In this case, additional air holes are formed on the bottom portion of the fire bowl, and the center opening on the bottom of the fire bowl is sealed around the shaft so that ash will not fall through the center opening.

The present invention will be described in more details in connection with by the following drawings.

### BRIEF DESCRIPTION OF THE DRAWINGS

These and other features, aspects and advantages of the present invention will become better understood with reference to the accompanying drawings, wherein:

FIG. 1 is an exploded view showing a barbecue grill according to the present invention;

FIG. 2 is a perspective view of a flange for attaching an ash container to an fire bowl of the present invention;

FIG. 3 is a perspective view of an ash container of the present invention;

FIG. 4 is a cross-sectional view of a fire bowl and a flange attached to the fire bowl of the present invention;

FIG. 5 is a cross-sectional view of the ash container of the present invention;

FIG. 6 is a perspective view of a washer placed between an ash container and a connection piece of the present invention;

FIG. 7 is a perspective view of a connection piece between an ash container and a motor of the present invention;

FIG. 8 is a perspective view of a motor used in the present invention;

FIG. 9 is a perspective view of a shaft of the present invention;

FIG. 10 is perspective view of a protection sleeve of the present invention; and

FIG. 11 is a cross-sectional view showing the rotary support mounted on a fire bowl of the present invention.

### DETAILED DESCRIPTION OF EMBODIMENTS

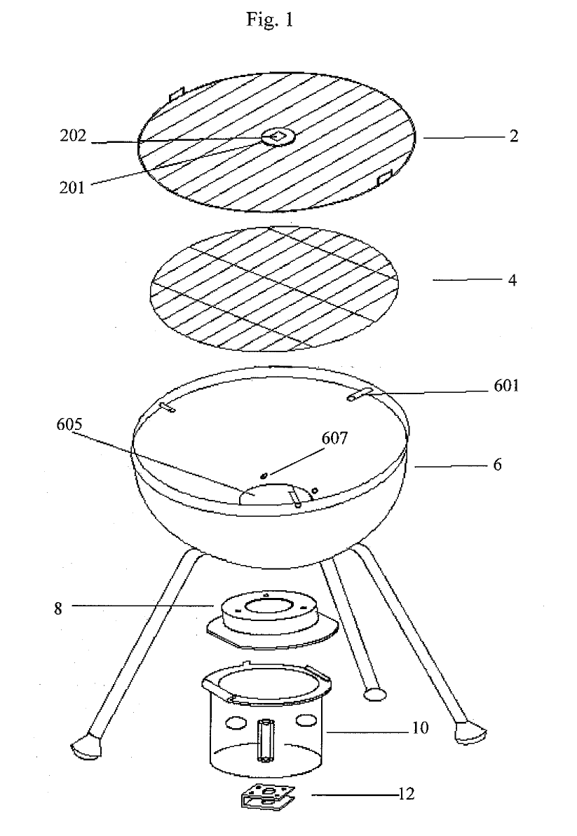

FIG. 1 shows an assembly view of a barbecue grill 1 according to the present invention in a vertically exploded alignment. As shown, the barbecue grill 1 includes a grill grid 2, a fire grid 4, and a fire bowl 6. Fire bowl 6 has an opening 605 at the center of its bottom. A flange 8 is fixed to the bottom of fire bowl 6 from beneath and aligned with the opening 605. An ash container 10 is removably attached to flange 8. A connection piece 12 is fixed to the bottom of ash container 10. A motor 14 is removably attached to the connection piece 12. A shaft 16 passes through fire bowl 6 and ash container 10, and engages with grill grid 2 at its upper end and with motor 14 at its lower end. Charcoal ash falls from fire bowl 6 into ash container 10 through opening 605. Opening 605 also functions as an air hole for supplying air to the charcoal fire on fire grid 4. Therefore, no additional air holes are required on the sidewall of fire bowl 6.

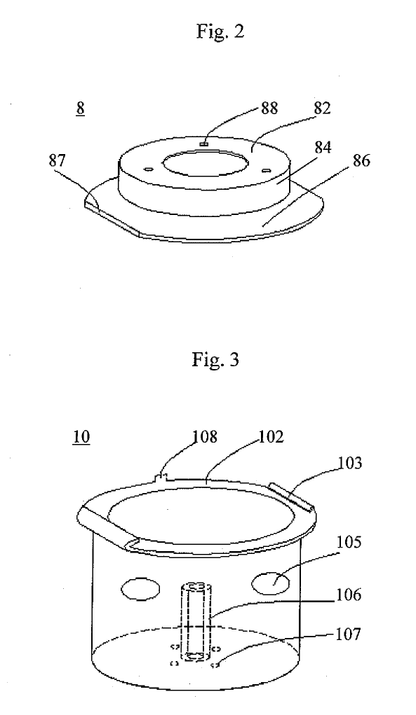

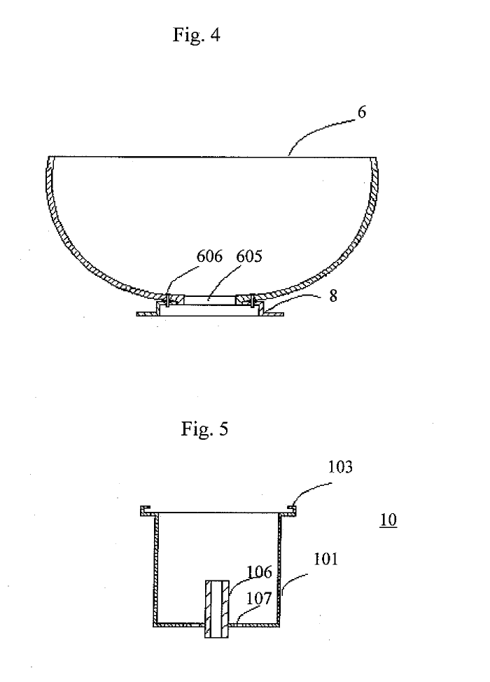

FIG. 2 shows a flange 8 according to an embodiment of the present invention for removably attaching ash container 10 to the bottom of fire bowl 6. In this embodiment, flange 8 has a cylindrical sidewall 84 connected to an inward extending upper edge 82 and an outward extending lower edge 86. Through holes 88 are formed on the inward extending upper edge 82. Holes 607 are formed on the fire bowl 6 corresponding to the locations of holes 88. There are two parallel straight portions 87 formed on opposite sides of the lower edge 86 for receiving ash container 10. As shown in FIG. 4, flange 8 is fixed to the bottom of fire bowl 6 with screws 606 through holes 607 on the fire bowl 6 and holes 88 on the flange 8. Alternatively, flange 8 can be welded to the bottom of fire bowl 6. In this case, the inward extending upper edge 82 and through holes 88 will not be necessary. Alternatively, the inward extending upper edge 82 can be made outward extending like the outward extending lower edge 86. Also, instead of a continuous edge, the inward extending upper edge 82 can be made of several separate pieces each containing one through hole 88. Flange 8 can be replaced with two separate pieces fixed to two opposite sides of the opening 605, which have the same function as the two parallel straight portions 87.

As shown in FIGS. 3 and 5, ash container 10 has cylindrical body 101 with an outward extending upper edge 102. A pair of hooks 103 are formed on opposite sides of the outward extending upper edge 102. When in use, the pair of hooks 103 engage with corresponding straight portions 87 of the lower edge 86 of flange 8, so that ash container 10 can be easily slid onto or off flange 8 so as to removably attach ash container 10 to fire bowl 6. Air holes 105 are formed on the upper portion of body 101. A tube 106 is inserted through a center hole on the bottom of ash container 10 providing a passage for shaft 16. Tube 106 can be fixed to the bottom of ash container 10 by a washer 11 as described below or by welding. The ash container 10 can also be provided with a handle on body 101. A stopper 108 is formed on the outward extending upper edge 102 between the pair of hooks 103 for positioning ash container 10 relative to flange 8 by engaging with the outward extending lower edge 86 of flange 8. FIG. 3 shows that body 101 has a cylindrical shape, but body 101 can have any desired shape. Alternatively, the outward extending upper edge 102 can be replaced with two separated pieces positioned at two opposite sides of the body 101 which have the same function as the two hooks 103. Screw holes 107 are provided on the bottom of ash container 10.

Various other connection mechanisms between fire bowl 6 and ash container 10 can be used to removably attach ash container 10 to the bottom of fire bowl 6. For example, flange 8 can be replaced by two separate pieces, each is fixed to the bottom of fire bowl 6 and each has an outward extending edge for engaging with the hook 103 of ash container 10, or each has an inward extending edge for receiving the outward extending upper edge 102 of ash container 10 (in this case, hooks 13 are no longer needed). In addition, the detachable attachment between the fire bowl 6 and the ash container 10 can be a rotary connection instead of the above discussed sliding connection. For example, instead of hooks 103, upright protrusions can be provided on the outward extending upper edge 102 of ash container 10. The upright protrusions may have a shank and a head having a larger dimension or diameter than that of the shank. Corresponding holes with a diameter that allows the head to pass through can be formed on the outward extending lower edge 86 of flange 8, and each of these corresponding holes is connected to a channel with a width smaller than the diameter of the head, but larger than the diameter of the shank. By inserting the head of the upright protrusions of ash contained 10 into corresponding holes of flange 8 and rotating ash container 10 relative to flange 8, the shank is slid into a corresponding channel so as to removably lock ash container 10 to flange 8.

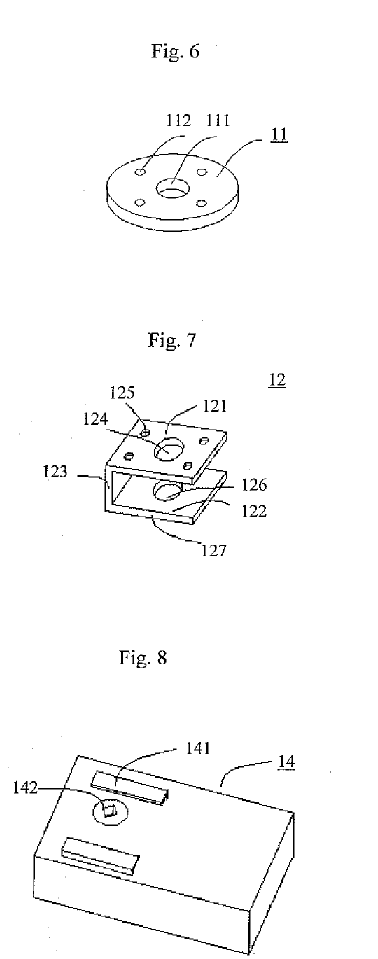

FIG. 6 shows a washer 11 having a center hole 111 and holes 112. The tube 106 is in tight fit with the center hole 111. When assembled, tube 106 is pressed into center hole 111 and fixed therein. Washer 11 is attached to the outer bottom of container 10 by rivet or screw through holes 112 of the washer 11 and holes 107 on the bottom of the ash container 10.

Motor 14 is removably attached to the bottom of ash container 10 through a connection piece 12. As shown in FIG. 7, connection piece 12 has an upper plate 121 and a lower plate 122 connected by a meddle portion 123, such as a vertical wall. A center hole 124 is formed in upper plate 121 for receiving tube 106. Holes 125 are provided for fixing upper plate 121 to the bottom of ash container 10. When assembled, the upper plate 121 is riveted or screwed to the washer 11 and the bottom of ash container 10 through holes 125, 112 and 107 with the lower end of tube 106 inserted into the center hole 124. A disk can be provided between the bottom surface of ash container 10 and the upper plate 121. The lower plate 122 also has a center hole 126 for receiving shaft 16.

As shown in FIG. 8, motor 14 is provided with a pair of hooks 141 on its upper surface for slidingly engaging with two opposite edges 127 of the lower plate 122 of connection piece 12. Through the engagement between the two opposite edges 127 of the lower plate 122 of connection piece 12 and the pair of hooks 141 on motor 14, motor 14 can be easily slid onto or off the connection piece 12. A rotating head 142 is removably attached to the lower end of shaft 16 to rotate the shaft and grill grid 2.

Motor 14 can be powered by either an AC source or a battery, or both. For example, motor 14 can be powered by two 1.5 v, No. 2 batteries and an AC source. Various suitable motors that can be used in the present invention are commercially available on the market. Therefore, no detailed descriptions of the motor will be given here.

Various connection mechanisms between ash container 10 and motor 14 can be used to removably attach motor 14 to the bottom of ash container 10.

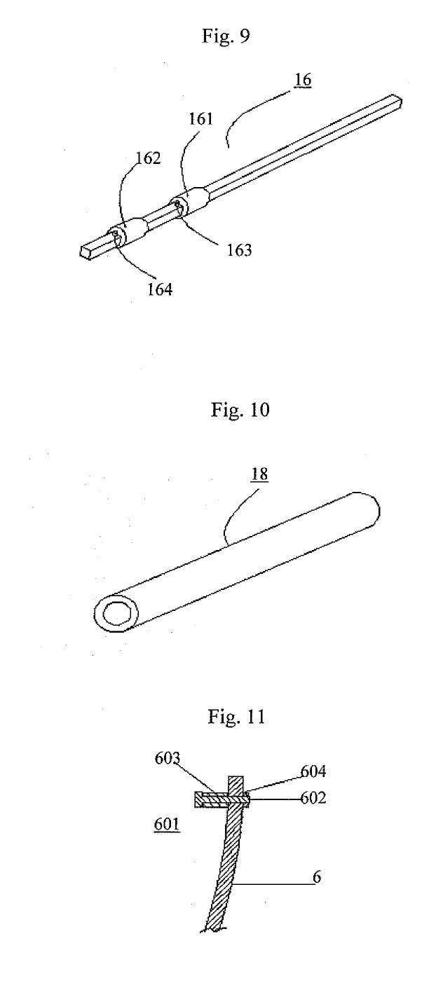

FIG. 9 shows a shaft 16 according to the present invention. Both the upper end and the lower end of shaft 16 have a polygonal cross-section for engaging with the grill grid 2 and the rotating head 142 of motor 14, respectively. When in use, the lower end of shaft 16 is inserted into and driven by the rotating head 142. Shaft 16 has a fixed cylindrical block 161 restricted by two stops 163 at its two ends and a movable cylindrical block 162 at a lower portion of shaft 16. Cylindrical block 162 can freely move along shaft 16 between stop 164 and stop 163. The diameter of the fixed cylindrical block 161 and the movable cylindrical block 162 corresponds to the inner diameter of tube 106. When assembled, both the fixed cylindrical block 161 and the movable cylindrical block 162 are inserted into tube 106 so as to align shaft 16 at an upright position.

FIG. 10 shows a protection sleeve 18 used in the present invention. The inner diameter of protection sleeve 18 corresponds to the outer diameter of tube 106. The protection sleeve 18 is placed over tube 106. When assembled, one end of protection sleeve 18 is in contact with the bottom of Fire bowl 6, the other end of protection sleeve 18 extends above fire grid 4, but below grill grid 2, to prevent ash from falling into tube 106 and rotating head 142.

Grill grid 2 has a center piece 201 with a center hole 202 for detachably receiving the upper end of shaft 16. The center hole 202 has a size and cross-sectional shape corresponding to that of the upper end of shaft 16, so that the upper end of shaft 16 can be inserted into the center hole 202 and drive grill grid 2 to rotate through the engagement between the center hole 202 of grill grid 2 and the upper end of shaft 16.

To support and position grill grid 2 and to facilitate the rotation of grill grid 2, rotary supports 601 are provided on the upper edge of fire bowl 6. As shown in FIG. 11, rotary support 601 includes a horizontally inward-extending shank 602 and a rotating sleeve 603 placed over shank 602. Rotating sleeve 603 can rotate freely on shank 602. Shank 602 is fixed to the sidewall of fire bowl 6 by nut 604 or by other means such as welding. When in use, the edge of grill grid 2 is supported by supports 601.

Fire grid 4 is placed in fire bowl 6 below grill grid 2 for holding charcoal. Charcoal ash falls into ash contained 10 through opening 605 at bottom of fire bowl 6.

If desirable, motor 14 can be removably attached to fire bowl 6 without ash container 10. For example, connection piece 12 can be directly fixed to the bottom of fire bowl 6 and motor 14 is removably attached to connection piece 12. In this case, air holes are provided on lower portion of fire bowl 6.

The present invention can be easily applied to various existing conventional charcoal barbecue grill by adding an ash container and a motor as described herein.

The present invention has been described using exemplary embodiments. However, it is to be understood that the scope of the present invention is not limited to the disclosed embodiments. On the contrary, it is intended to cover various modifications and similar arrangement or equivalents. The scope of the claims, therefore, should be accorded the broadest interpretation so as to encompass all such modifications and similar arrangements and equivalents.

1. A barbecue grill comprising:
a fire bowl having an opening at its bottom portion;
a grill grid to be rotatably placed in the fire bowl;
a shaft passing through the opening of the fire bowl and removably engaging with the grill grid;
an ash container removably attached to the fire bowl beneath the opening of the fire bowl; and
a motor removably attached to the ash container for rotating the shaft so as to rotate the grill grid.

2. The barbecue grill of claim 1, further comprising a flange attached to the bowl beneath the opening of the fire bowl, wherein the flange has an outward extending edge for engaging with the ash container.

3. The barbecue grill of claim 2, wherein the ash container has two grooves at opposite sides of its upper portion for sliding engagement with the outward extending edge of the flange.

4. The barbecue grill of claim 1, further comprising a connection piece having an upper plate with a first center hole and a lower plate with a second center hole, wherein the upper plate is attached to a bottom of the ash container, and the motor has two grooves on its upper surface for sliding engagement with the lower plate of the connection piece.

5. The barbecue grill of claim 4, wherein the ash container has an opening at the bottom connected to a sleeve extending upward into the bowl through the opening of the bowl, the shaft passes through the sleeve of the ahs container, the first hole of the connection piece and the second hole of the connection piece, and removably engages with a receiving hole on a top surface of the motor.

6. The barbecue grill of claim 1, wherein the shaft has an upper end with a polygonal cross section, and the grill grid has a center hole with a polygonal cross section for engaging with the upper end of the shaft.

7. The barbecue grill of claim 1, wherein the ash container has a handle on its outer side wall.

8. The barbecue grill of claim 1, wherein the opening at the bottom portion of the fire bowl is connected to the ash container allowing ash to fall into the ash container from the fire bowl.

9. The barbecue grill of claim 1, further comprises a fire grid position below the grill grid for holding charcoal.

10. A barbecue grill comprising:
a fire bowl having an opening at its bottom portion;
a grill grid to be rotatably placed in the fire bowl;
a shaft passing through the opening of the fire bowl and removably engaging with the grill grid;
a motor removably attached to the fire bowl for rotating the shaft so as to rotate the grill grid.

11. The barbecue grill of claim 10, further comprising a connection piece having an upper plate with a first center hole and a lower plate with a second center hole, wherein the upper plate is attached to a bottom of the fire bowl, and the motor has two grooves on its upper surface for sliding engagement with the lower plate of the connection piece.
